(19) United States
(12) Patent Application Publication
(10) Pub. No.: US 2010/0093483 A1
(43) Pub. Date: Apr. 15, 2010

(54) DIFFERENTIAL ASSEMBLY WITH ONE-PIECE DIFFERENTIAL CARRIER AND FOUR DIFFERENTIAL GEARS

(76) Inventor: Werner Krude, Neunkirchen-Seelscheid (DE)

Correspondence Address: GKN Driveline/TTG, c/o Kristin L. Murphy, 39533 Woodward Avenue, suite 140, Bloomfield Hills, MI, 48304, US

(21) Appl. No.: 12/063,431

(22) PCT Filed: Jul. 22, 2006
(86) PCT No.: PCT/EP2006/007227

§ 371 Date: Apr. 2, 2009

(30) Foreign Application Priority Data
Aug. 8, 2005 (DE) 10 2005 037 397.6

(51) Int. Cl. F16H 48/06

(52) U.S. Cl. 475/244

(57) ABSTRACT

The invention relates to a differential assembly, more particularly for being used in the driveline of a motor vehicle, comprising a one-piece differential carrier 3, 53 which is rotatingly drivable around an axis of rotation (A) and, in a casing portion 26, comprises at least one assembly aperture 16 and, in each of two cover portions arranged opposite one another, comprises an integrally formed-on bearing projection; sideshaft gears 9, 10 which can be inserted into the differential carrier 3 through the assembly aperture 16 and, in the mounted condition, are rotatably held in the differential carrier 3 on the axis of rotation A; four differential gears 8 which can be inserted into the differential carrier 3 through the assembly aperture 16 and, in the mounted condition, rotate together with the differential carrier 3 around the axis of rotation A and engage the sideshaft gears 9, 10; a cross member assembly 7 which is drivingly connected to the differential carrier 3 in respect of rotation thereof and comprises four journals 17, 18, 19, 20, wherein the four journals, in the mounted condition, each carry one of the differential gears 8 and wherein at least two of the four journals are designed in such a way that they can be inserted through the assembly aperture 16.

The invention relates to a differential assembly which forms part of a differential drive and, more particularly, serves to be used in the driveline of a motor vehicle. Such differential assemblies are sufficiently known. They commonly comprise a differential carrier rotatingly drivable around an axis of rotation, two sideshaft gears which are rotatably held in the differential carrier and which serve to transmit torque to two sideshafts, as a well as a plurality of differential gears which rotate jointly with the differential carrier and whose teeth engage those of the sideshaft gears.

From WO 2005/040641 A1, there is known a differential assembly with a two-piece differential carrier which comprises a cup-shaped carrier part with a first bearing projection and a cover-shaped carrier part which closes the cup-shaped carrier part and is provided with a second bearing projection. The sideshaft gears and the differential gears are axially inserted into the cup-shaped carrier part which is subsequently closed by the cover-shaped carrier part. There are provided four differential gears which are supported on four journals of a cross member, with two of the four journals being produced so as to being of an integral nature and forming a central transverse aperture into which the two remaining journals are inserted.

From DE 101 44 200 A1 there is known a differential assembly in the form of a crown gear differential. The differential carrier has four apertures for mounting the differential gears. Radially inwardly directed ribs are formed on to the webs formed between said assembly aperture and are connected to a journal element. The journals each project into the four assembly apertures and, at their ends, comprise annular grooves which are engaged by axial securing rings for fixing the differential gears. The crown gears are axially inserted into the lateral ends of the differential carrier and fixed relative thereto by large axial securing rings.

U.S. Pat. No. 5,951,431 proposes a differential assembly in the form of a bevel gear differential with a one-piece differential carrier. For mounting the gear set, the differential carrier comprises two opposed assembly apertures. In the circumferential direction, between the assembly openings, there are provided bores into which, after the insertion of the gear set, there is inserted a journal part for supporting two differential gears.

It is the object of the present invention to propose a differential assembly which features a high strength and torsional stiffness, which comprises a compact design and can thus be produced cost-effectively and is able to transmit high torque values.

In accordance with the invention, the objective is achieved by providing a differential assembly comprising a differential carrier which is rotatingly drivable around an axis of rotation and, in a casing portion, comprises at least one assembly aperture and in each of two cover portions arranged opposite one another, comprises an integrally formed-on bearing projection; sideshaft gears which can be inserted into the differential carrier through the assembly aperture and, in the mounted condition, are rotatably held in the differential carrier on the axis of rotation; four differential gears which can be inserted into the differential carrier through the assembly aperture and, in the mounted condition, rotate together with the differential carrier around the axis of rotation and engage the sideshaft gears; a cross member assembly which is drivingly connected to the differential carrier in respect of rotation thereof and comprises four journals, wherein the four journals, in the mounted condition, each carry one of the differential gears and wherein at least two of the four journals are designed in such a way that they can be inserted through the assembly aperture; the differential carrier comprising the jacket part and the cover portions is produced in one piece.

By using a cross member assembly with four journals and four differential gears, it is possible for the inventive differential assembly to transmit relatively high torque values from the differential carrier to the sideshaft gears. Applications in which the nominal torque values are lower, for example when the differential assembly is used in the driveline of a motor vehicle with a lower engine power, it is possible to eliminate the third and fourth journal without having to change the design of the differential carrier or of the first journal part. This is particularly advantageous in the sense of the concept of having identical parts. The differential carrier which is produced in one piece achieves a high strength and torsional stiffness, which has an advantageous effect on the service life. “Produced in one piece” in this context means that the differential gears and the sideshaft gears are mounted entirely through the at least one assembly aperture in the casing portion and that the differential carrier comprises two integral cover parts with formed-on bearing projections for being supported in a stationary housing, which cover parts are passed through by the sideshafts only. The differential assembly is preferably provided in the form of a crown gear differential, with the sideshaft gears comprising crown teeth and the differential gears spur teeth. This measure is advantageous in that it achieves a short axial length and thus a relatively low weight. Alternatively, the differential assembly can be provided in the form of a crown gear differential, in which case the sideshaft gears and the differential gears are provided in the form of bevel gears.

The first journal and the second journal are drivingly connected to the differential carrier in respect of rotation thereof, with the third and the firth journal, at their inner ends, being connected to the first and the second journal. According to a first solution, the third and the fourth journals, at their outer ends, are not supported in the circumferential sense relative to the differential carrier.

According to a first embodiment, the first and the second journal are produced in one piece and jointly form a first journal part, and the third and the fourth journal are produced in one piece and jointly form a second journal part which is connected to the first journal part in such a way that it is possible for torque to be transmitted from the first journal part to the second journal part. The first journal part can be fixed in the differential carrier in several ways. According to a first variant, the casing portion of the differential carrier is provided with diametrically opposed bores into which the first journal part is inserted with its first journal and its second journal, with the opposed bores being circumferentially offset relative to the at least one assembly aperture. According to a second variant, there are provided two assembly apertures into each of which there is inserted a bearing disc, with the first journal part with its first and its second journal being accommodated in the bearing discs. The torque is transmitted in the rotational direction from the differential carrier via the bearing disc to the first journal part. By arranging the bearing discs in the assembly apertures, the differential carrier is provided with a high torsional stiffness and a high strength because the bearing discs have a stiffening effect in the circumferential direction. Furthermore, it is possible to eliminate additional bores in the jacket part of the differential carrier for inserting journals. According to a third variant, which constitutes a combination of the first variant and of the second variant, there is provided a bore which is positioned diametrically opposite the assembly aperture and into which there is inserted the first journal part with its first journal; the second journal is connected to the bearing disc which is located in the assembly aperture. The second journal and the bearing disc can also be produced in one piece, which has an advantageous effect on production and assembly.

According to a second embodiment, the first and the second journal are produced separately from one another and are connected to the second journal part for transmitting torque.

It applies to both embodiments that, if two assembly apertures are used, these should preferably be arranged so as to be circumferentially offset relative to one another by 180°. The third and the fourth journal are preferably positioned perpendicularly on the first journal part. It is advantageous for the first journal part to be cylindrical in shape. It can simply be inserted into the bores in the jacket portion of the differential carrier and, respectively, into bores of the bearing discs inserted into the assembly apertures of the differential carrier and axially fixed relative thereto. This is achieved by at least one securing ring which engages an annular groove in the first journal part. Using only one securing ring is advantageous from the point of view of production and assembly costs. However, it is also possible to use one securing ring per journal.

According to a preferred proposal which also applies to both embodiments, the one-piece journal part is designed in such a way that it can be introduced into the differential carrier through one of the assembly apertures. In the case of the variant wherein the first journal part is inserted into the bores in the casing portion of the differential carrier, the journals of the second journal part project in a contact-free condition into the assembly apertures. In the case of those variants wherein the first journal part is received in at least one bearing disc, the second journal part is fully accommodated inside the differential carrier and points with its journals towards the webs formed in the circumferential direction between the assembly apertures. The third and the fourth journal preferably comprise spherical end faces whose curvature is adapted to the internally cylindrical face of the differential carrier. The second journal part preferably comprises a transversely extending through-bore into which there is inserted the first journal part. The axes of the first and of the second journal part enclose more particularly a right angle. Inserting the journal parts into one another is advantageous in that there is no need for further means for fixing the second journal part to the differential carrier and that the second journal part can be held without any additional component so as to extend coaxially relative to the axis of rotation of the differential carrier. The second journal part preferably comprises sleeve portions which adjoin the through-bore and which form abutment faces for the differential gears supported on the journals of the first journal part. Furthermore, the third and the fourth journal preferably comprise shoulders against which the third and the fourth differential gears are able to abut on the inside. By applying this measure, there is achieved the smallest possible number of parts, the differential gears are held in the region of teeth engagement of the crown gears and cannot move radially inwardly along the journal axes. To achieve the advantage of providing a differential assembly which is axially particularly short, the second journal part—with reference to the axis of rotation A of the differential carrier—can comprise axial flattened regions. The recesses formed in this way can be engaged by the sideshafts inserted in a rotationally fast way into the sideshaft gears. Alternatively to the flattened regions, the second journal part can also comprise a through-bore extending coaxially relative to the axis of rotation A and the first journal part can comprise a central portion whose axial extension is reduced relative to the axis of rotation A. The sideshafts are thus able to enter the through-bore and the recess of the first journal part, so that there is achieved a short axial length.

According to a second solution, the third and the fourth journals, at their outer ends, are drivingly connected to the differential carrier in the circumferential direction. At their inner ends, the third and the fourth journal are connected to the first and to the second journal.

According to a first embodiment of the second solution, the first and the second journal are produced in one piece and jointly form a first journal part. The third and the fourth journal are also produced in one piece and jointly form a second journal part. The first and the second journal part are substantially formed in accordance with the above description. The first journal part is inserted into the through-bore of the second journal part and, by means of its journals, is located in the bores of the casing portion. The third and the fourth journal are preferably drivingly connected to the differential carrier in the circumferential direction via bearing discs inserted into the assembly apertures of the differential carrier. However, the first and the second journal part can also be connected to one another without making use of a bore. For example, the two journal parts can be of identical shape and comprise transverse grooves by means of which they engage one another and are axially secured relative to one another.

According to a second embodiment of the second solution, the third and the fourth journal can be produced separately and they can be connected at their inner ends to the first journal part. For this purpose, the third and the fourth journal, at their inner ends, each comprise a plug-in projection by means of which they are inserted into a central through-aperture of the first journal part. At their outer ends, the third and the fourth journal preferably comprise integrally formed-on bearing discs by means of which they are received in the assembly apertures of the differential carrier and connected in respect of drive in the circumferential direction.

According to a third embodiment of the second solution, the third and the fourth journal are produced separately and, at their inner ends, they are connected to a support element connected to the first journal part. The first journal part, with its first and second journals, is preferably inserted into bores in the jacket portion, which bores are circumferentially offset relative to the assembly apertures. The support element preferably comprises a through-bore which extends transversely to the axis of rotation and into which there is inserted the first journal part, as well as two further bores which extend transversely to the through-bore into which there are inserted the third and the fourth journals. It is advantageous for the support element to comprise per journal a shoulder against which the respective differential gears are able to abut, at least indirectly on the inside. An abutment disc can be arranged between the shoulder and the differential gear. The third and the fourth journal, on their respective inner ends, are fixed to the support element by means of a securing ring. On their outer ends, the third and the fourth journal preferably comprise integrally formed-on bearing discs by means of which they are received in the assembly bores.

It applies to all the above-mentioned embodiments that, if two assembly apertures are used, these are identical in shape in order to avoid any out-of-balance. Furthermore, the assembly apertures are preferably symmetrical with reference to the longitudinal central plane. The journals of the cross member assembly are axially fixed in the bores of the bearing discs arranged opposite one another and, respectively, of the casing portion, which axial fixing is preferably effected by securing rings which engage annular grooves of the journals. In all the above embodiments with bearing discs, these are held in a play-free way relative to the differential carrier, at least in the circumferential direction of same. There is thus ensured a play-free transmission of the torque introduced from the differential carrier to the bearing discs and to the journals associated therewith. At each of the assembly apertures, the differential carrier preferably comprises two supporting faces which are arranged opposite one another in the circumferential direction and by means of which the associated bearing disc is in contact in the mounted condition. In order to achieve a circumferentially directed introduction of torque from the differential carrier into the bearing discs, the supporting faces are positioned on a cross-sectional plane through the journal axis or adjoin same directly.

Preferred embodiments of the inventive differential assembly will be explained below with reference to the drawing wherein

FIG. 1 shows an inventive differential assembly according to a first embodiment in a radial view.

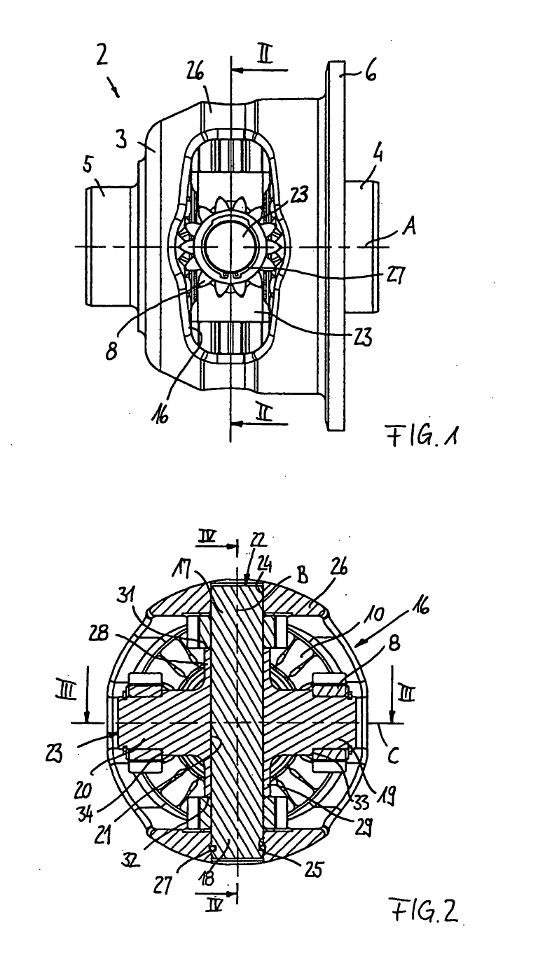

FIG. 2 shows the differential assembly according to sectional line II-II of FIG. 1.

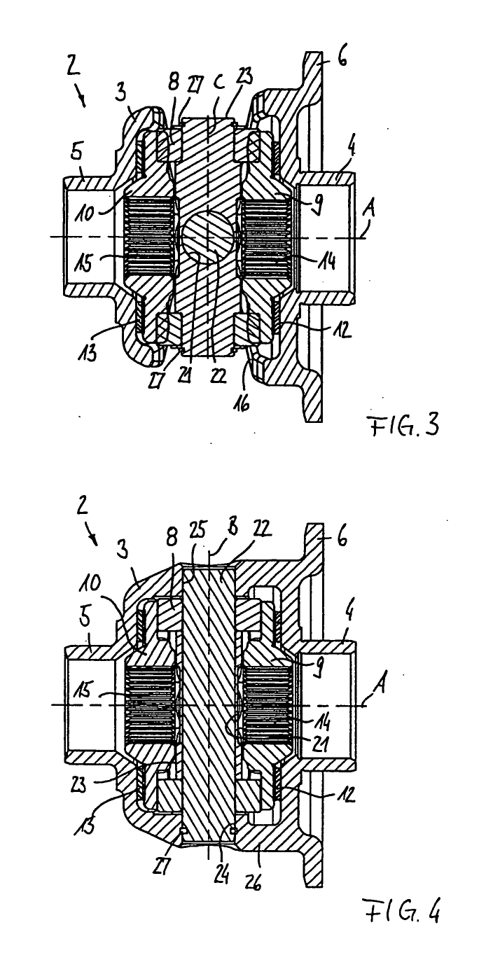

FIG. 3 shows the differential assembly according to sectional line of FIG. 2.

FIG. 4 shows the differential assembly according to sectional line IV-IV of FIG. 2.

FIG. 5 shows the cross member assembly of FIG. 1 in a plan view.

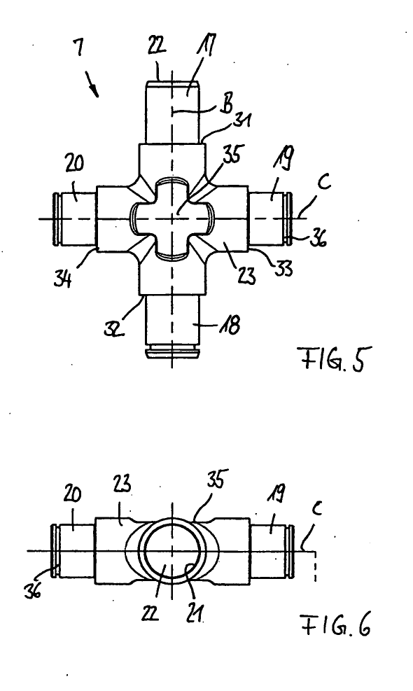

FIG. 6 shows the cross member assembly of FIG. 1 in a side view.

FIG. 7 shows an inventive differential assembly according to a second embodiment in a radial view.

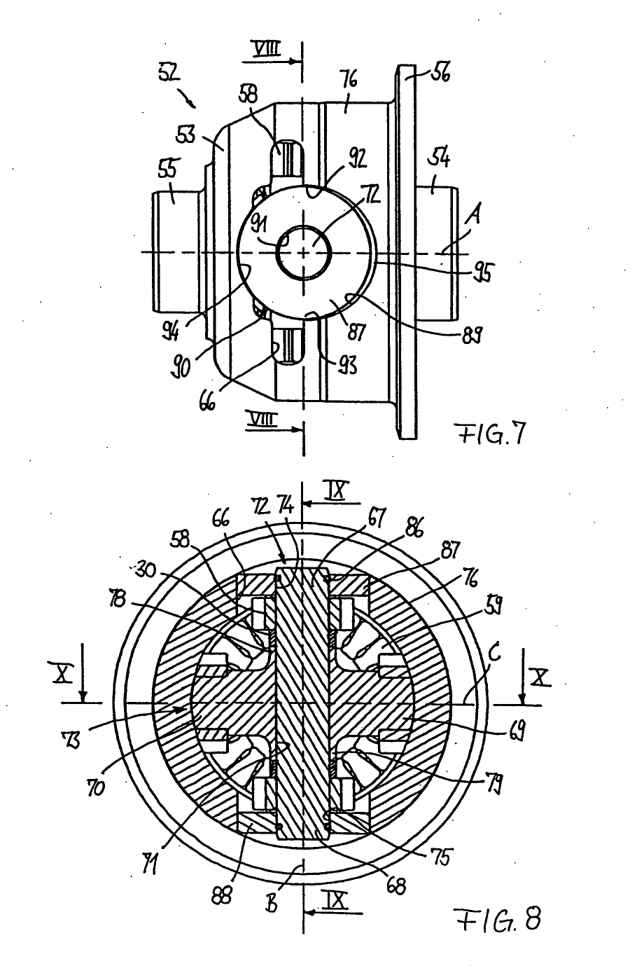

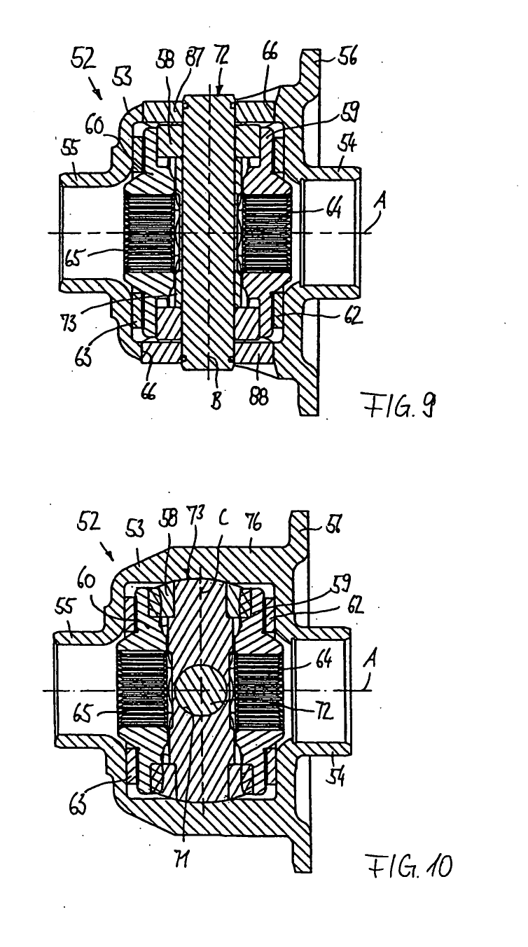

FIG. 8 shows the differential assembly of FIG. 7 according to sectional line VIII-VIII.

FIG. 9 shows the differential assembly of FIG. 8 according to sectional line IX-IX.

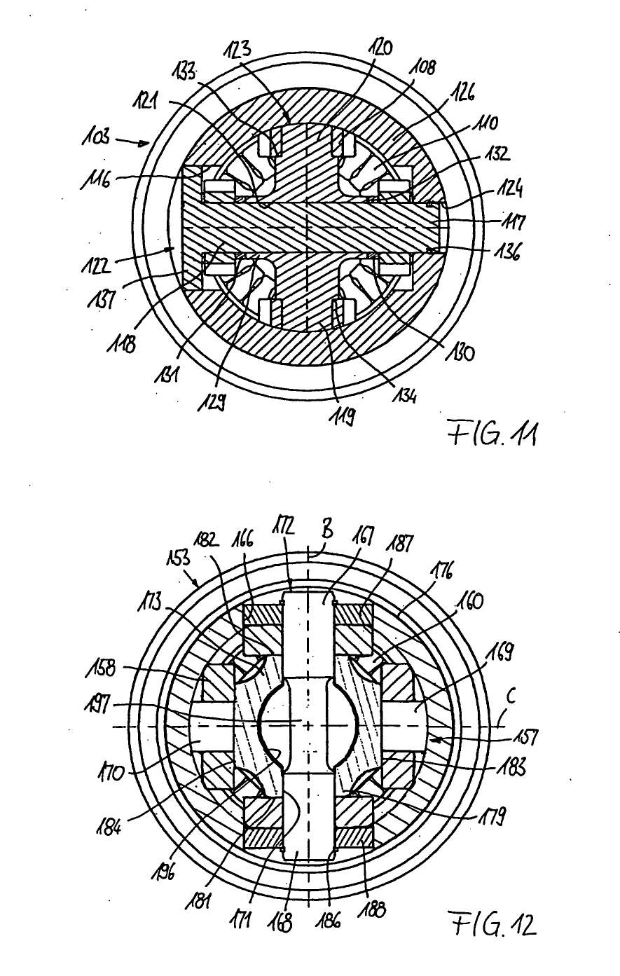

FIG. 10 shows the differential assembly of FIG. 8 according to sectional line X-X.

FIG. 11 shows an inventive differential assembly according to a third embodiment in a cross-sectional view.

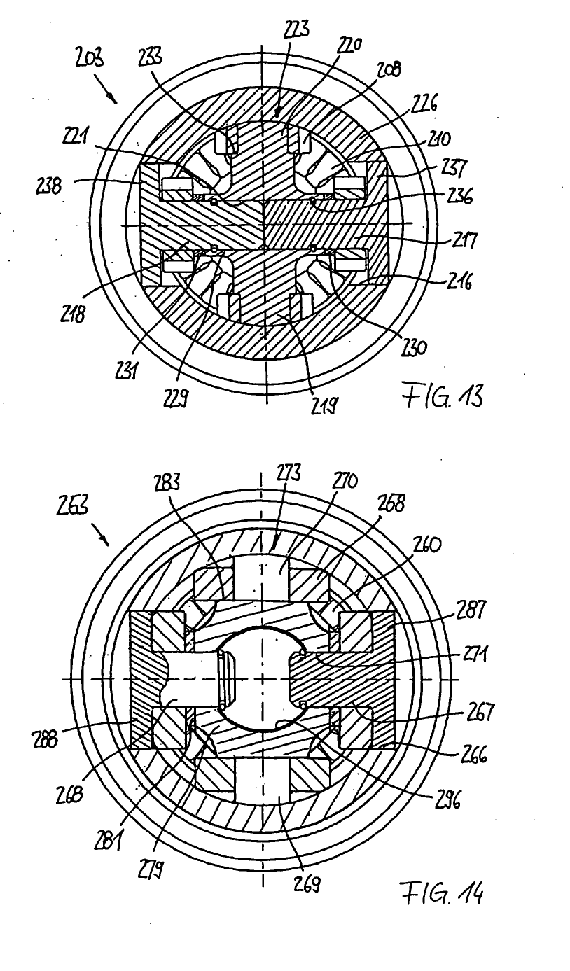

FIG. 12 shows an inventive differential assembly according to a fourth embodiment in a cross-sectional view.

FIG. 13 shows an inventive differential assembly according to a fifth embodiment in a cross-sectional view.

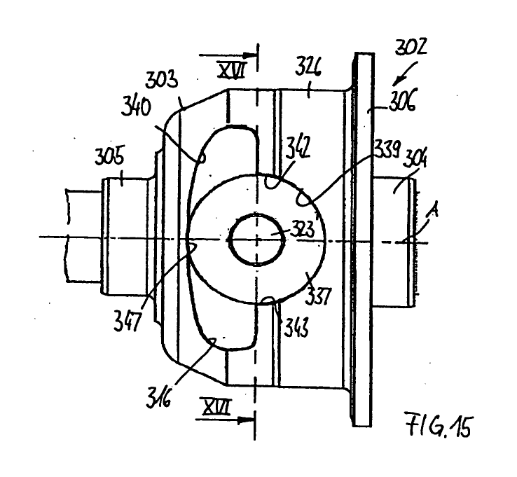

FIG. 14 shows an inventive differential assembly according to sixth embodiment in a cross-sectional view.

FIG. 15 shows an inventive differential assembly according to seventh embodiment in a radial view.

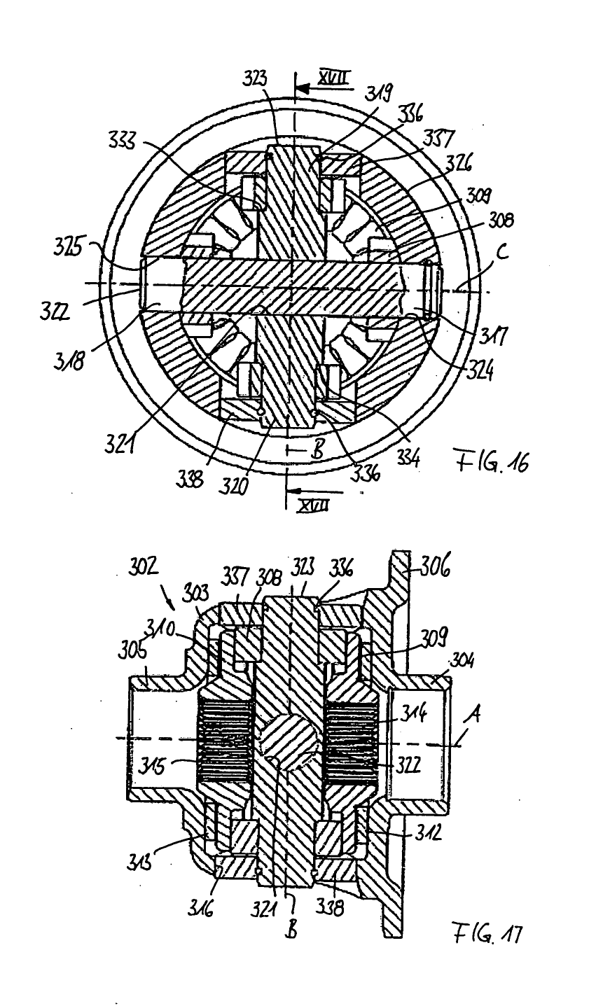

FIG. 16 shows the differential assembly according to FIG. 15 along sectional line XVI-XVI.

FIG. 17 shows the differential assembly according to FIG. 16 along sectional line XVII-XVII.

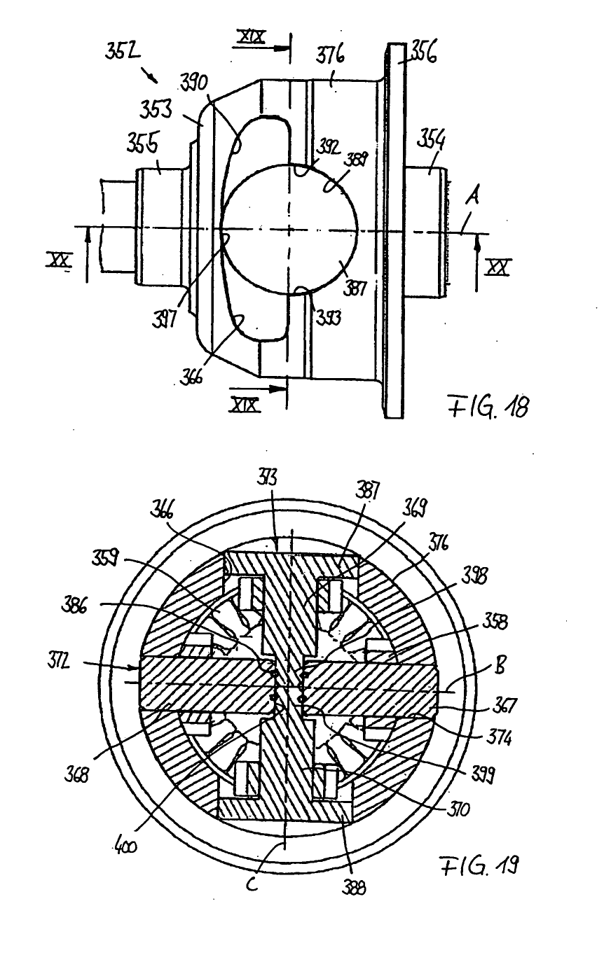

FIG. 18 shows an inventive differential assembly according to an eighth embodiment in a radial view.

FIG. 19 shows the differential assembly according to FIG. 18 along sectional line XIX-XIX.

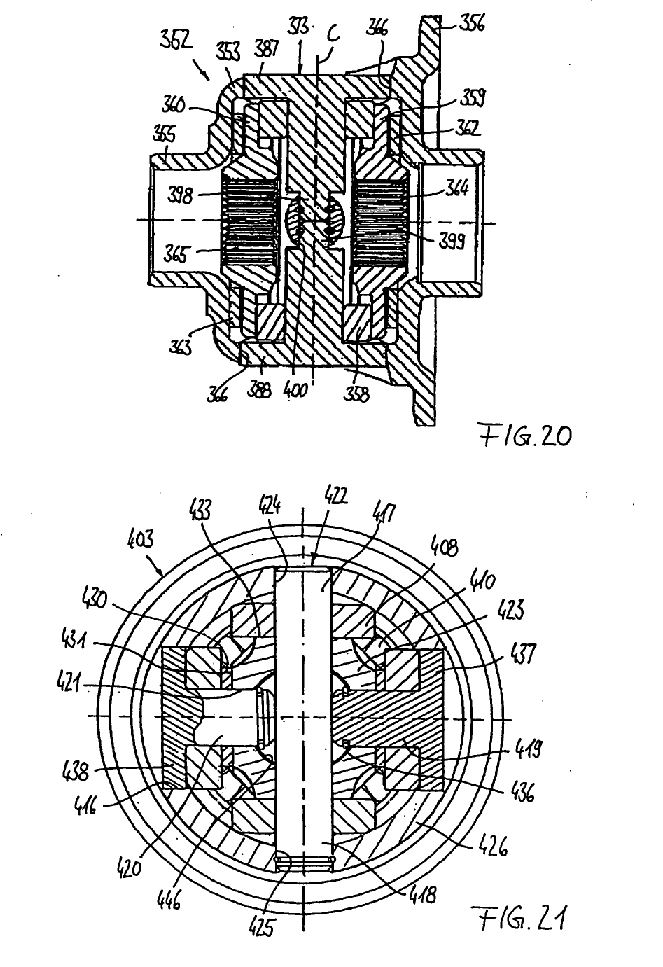

FIG. 20 shows the differential assembly according to FIG. 18 along sectional line XX-XX.

FIG. 21 shows an inventive differential assembly according to a ninth embodiment in a cross-sectional view.

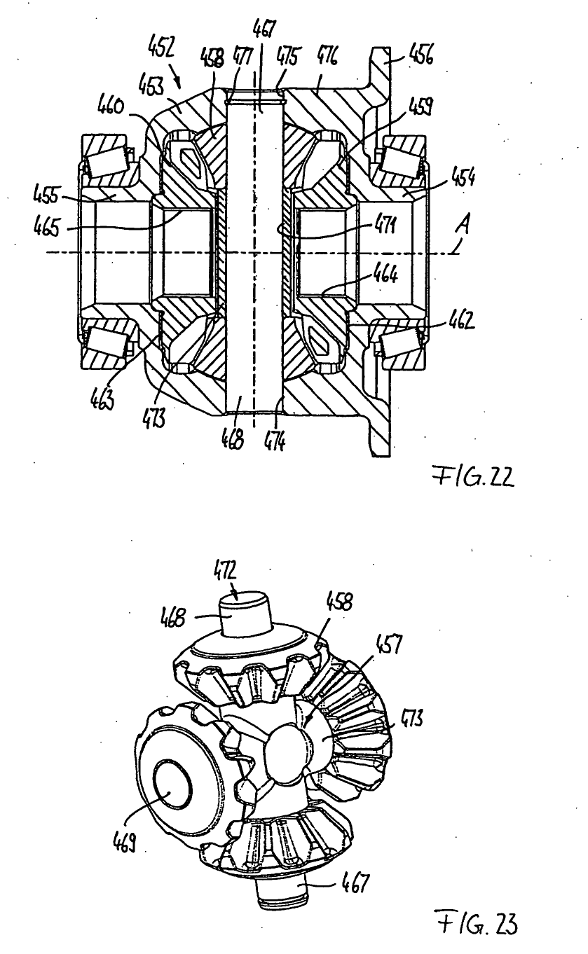

FIG. 22 shows an inventive differential assembly according to a tenth embodiment in a cross-sectional view.

FIG. 23 shows the cross member assembly according to FIG. 22 in a perspective view.

Below, FIGS. 1 to 6 will be described jointly. They show a differential assembly 2 with a one-piece differential carrier 3 which has to be supported in a stationary housing (not illustrated). For this purpose, two bearing projections 4, 5 which point in opposite directions and on to which there is slid a rolling-contact bearing (not illustrated here) are formed on to the differential carrier 3. The differential carrier 3 is produced in one piece in the form of a casting so that it comprises a high degree of stiffness. The differential assembly 2 forms part of a differential drive in the driveline of a motor vehicle and serves to transmit torque from a propeller shaft to two sideshafts. For this purpose, the differential carrier 3 is provided with a formed-on flange 6 to which there can be attached a ring gear for introducing torque into the differential assembly 2. Via four differential gears 8 rotatably supported on a cross member assembly 7 and jointly rotating with the differential carrier 3, the introduced torque is transmitted to sideshaft gears 9, 10 which engage die differential gears 8. As is common practice, the sideshaft gears 9, 10 are axially supported relative to the differential carrier 3 by friction-reducing abutment discs 12, 13. The sideshafts which are connected via longitudinal teeth 14, 15 to the sideshaft gears 9, 10 are positioned coaxially inside the sleeve-shaped bearing projections 4, 5 and pass through the differential carrier 3 in the axial direction.

The differential assembly 2 is provided in the form of a crown gear differential, with the sideshaft gears 9, 10 being crown gears and the differential gears 8 being spur gears. This results in a compact design and low weight. For mounting the sideshafts gears 9, 10 and the differential gears 8, there are provided assembly apertures 16. They are positioned diametrically opposite one another, comprise identical contours and are designed symmetrically relative to the longitudinal central plane in order to avoid any undesirable out-of-balance. Each of the assembly apertures 16 is just large enough for inserting the sideshaft gears 9, 10 and the differential gears 8 into the differential carrier 3.

For transmitting the torque from the differential carrier 3 to the sideshaft gears 9, 10, there are provided four differential gears 8 which are each rotatably supported on an associated journal 17, 18, 19, 20 of the cross member assembly 7. As is particularly obvious from FIG. 2, the first and the second journal 17, 18 are produced in one piece and jointly form a first cylindrical journal part 22. The third and the fourth journal 19, 10 are also produced in one piece and jointly form a second journal part 23. The first journal part 22 is inserted into bores 24, 25 in the casing portion 26 of the differential carrier 3 and axially secured relative thereto by a securing ring 27. The second journal part 23 is circumferentially secured to the first journal part 22, so that torque is transmitted from the first to the second journal part. For this purpose, the second journal part 23 comprises a transversely extending through-bore 21 which is inserted into the first journal part 22, with the axes B, C of the two journal parts 22, 23 enclosing a right angle with one another.

The second journal part 23 is unsupported relative to the differential carrier 3, so that the production tolerances of the assembly apertures 16 can remain rough. In order to ensure good supporting conditions and a high degree of stiffness, the second journal part 23 comprises two sleeve portions 28, 29 which are provided in the region adjoining the through-bore 21 and via which the torque is transmitted in the circumferential direction of the differential carrier 3. The length of the sleeve portions 28, 29 is such that their end faces form abutment faces 31, 32 for the differential gears 8 supported on the journals 17, 18 of the first journal part 22. The third and the fourth journal 19, comprise shoulders 33, 34 against which the third and the fourth differential gears 8 are able to abut on the inside. In this way, it is ensured that the differential gears 8 are held by their spur teeth in the region of the crown teeth of the sideshaft gears 9, 10. As is particularly obvious in FIGS. 5 and 6, the second journal part 23, with reference to the axis of rotation A of the differential carrier, comprises axial flattened portions 35. The recesses formed in this way can be entered by the sideshafts inserted into the sideshaft gears 9, 10 in a rotationally fast way. In this way, it is ensured that the differential assembly 2 has a particularly short axial length. Furthermore, the journals 18, 19, 20 are shown to comprise grooves 36 which are engaged by securing rings for axially fixing the differential gears 8.

FIGS. 7 to 10 showing a second embodiment of an inventive differential assembly will be described jointly below. As far as design is concerned, the differential assembly as illustrated largely corresponds to the differential assembly shown in FIGS. 1 to 6, so that in view of the characteristics they have in common, reference is made to the above description, with components corresponding to one another having been given reference numbers increased by 50. The present embodiment differs in respect of the shape of the assembly openings 66 in each of which there is accommodated an annular-disc-shaped bearing disc 87, 88 in a play-free way. The first journal part 72 is inserted into bores 74, 75 of the bearing discs 87, 88 and is axially secured relative thereto. The dimensions and tolerances are such that torque in transmitted in the circumferential direction from the differential carrier 53 via the bearing discs 87, 88 to the first journal part 72. The casing portion formed in the circumferential direction between the assembly apertures 66 does not contain any through-apertures, so that there is achieved a high degree of stiffness of the differential carrier 53. The journals 69, 70 of the second journal part 73 are therefore shorter than the journals 67, 68 of the first journal part and comprise spherical end faces by means of which the journals 69, 70, as can be been in FIG. 10, rest in an unsupported way against the inner cylindrical faces of the differential carrier 53, with no direct transmission of force taking place from the carrier 53 to the second journal part 73. The journals 67, 68 are provided with annular grooves which are each engaged by a securing ring 86 for fixing the first journal part 72 relative to the bearing discs 87, 88. The sleeve portions 78 are shortened relative to the first embodiment, so that the second journal part 73 can be threaded into the modified assembly aperture 66. In order to ensure that the differential gears 58 of the first journal part 72 are nevertheless supported on their inside, spacing sleeves 39 are positioned on the sleeve portions 78, against which spacing sleeves 30 the differential gears 58 are able to abut.

It is particularly obvious from FIG. 7, that the assembly apertures 66 are formed by two overlapping areas of which a first area 89 describes approximately a circle and of which a second area 90 is greater than a radial projection of the sideshaft gears 59, 60. In a radial view, the circle described by the first area 89 approximately corresponds to the outer circumference of the bearing discs 87, 88. The second area 90 is substantially formed by a circumferentially extending slot whose shape, in a radial view, approximately corresponds to the radial projection of the sideshaft gears 59, 60. With reference to a plane formed by the journal axes B, C, the slot is arranged away from the flange 56. This means that the region of force transmission between the flange 56 and the regions of contact with the bearing discs 87, 88 is subjected to a small amount of weakening only. The contact points are formed by two circumferentially opposed supporting faces 92, 93 against which the associated bearing disc 87, 88 is supported in the circumferential direction. The torque is transmitted from the differential carrier 53 to the bearing discs 87, 88 via the supporting faces 92, 93, i.e. in the plane formed by the journal axes B, C. The bearing discs 87, 88 are axially supported against the differential carrier in the region of the slots, with a supporting portion 94 positioned away from the flange 56 being formed by a radius which corresponds to the radius of the bearing discs 87, 88. In this region, the bearing discs thus rest against the supporting portion 94 in a planar way. In the axially opposite region between the two contact regions 92, 93, the bearing discs 87, 88 are not supported relative to the differential carrier 53. There is formed a sickle-shaped gap 95 between the bearing discs 87, 88 and the differential carrier 53, so that the production tolerances can remain rough in this region. The tolerances in the three contact regions 92, 93, 94 have been selected to be such that the bearing discs 87, 88 are positioned in the respective assembly apertures 66 with a slight press fit. Towards the outside, the bearing discs 87, 88 are held relative to the differential carrier 53 by means of securing rings 86.

The embodiment shown in FIG. 11 largely corresponds to that shown in FIGS. 7 to 10. To that extent, as far as the common characteristics are concerned, reference is made to the above description, with those components which correspond to one another, having been given reference numbers increased once more by 50. The present embodiment is characterized in that the differential carrier 103 comprises one assembly aperture 116 and a bore 124 positioned diametrically opposite the latter. The sideshaft gears 119, 120 and the differential gears 108 are inserted into the differential carrier 103 through the assembly aperture 116. The first journal part 122 is produced in one piece and inserted with its first journal 117 into the bore 124 and with its second journal 118 is integrally connected to the bearing disc 137. The bearing disc 137 is held in a play-free way in the assembly aperture 116.

As far as design is concerned, the differential assembly shown in FIG. 12 also largely corresponds to that shown in FIGS. 7 to 10. To that extent, as far as the common characteristics are concerned, reference is made to the above description, with those components which correspond to one another having been given reference numbers increased by 100 relative to the embodiment shown in FIGS. 7 to 10. The only difference refers to the design of the cross member assembly 157. The second journal part 173 comprises an annular part with a through-bore 196 which extends coaxially relative to the axis of rotation A and whose diameter has been selected to be such that the sideshafts are able to enter said through-bore. The annular part comprises a solid wall and, by means of its sleeve portions 179, supports the first cylindrical journal part 172 over a relatively long distance outwardly, so that there is achieved a high degree of rotational stiffness. The first journal part 172 comprises a central portion 197 with a reduced diameter, so that, with reference to the axis of rotation A, there is obtained a reduced axial extension. The sideshafts are thus able to enter the through-bore 196 of the second journal part 173 and the recess 197 of the first journal part 172, so that there is achieved a short axial length.

As far as design is concerned, the differential assembly shown in FIG. 13 is similar to that shown in FIGS. 7 to 10. To that extent, as far as the common characteristics are concerned, reference is made to the above description, with those components which correspond to one another having been given reference numbers increased by 150 relative to the embodiment shown in FIGS. 7 to 10. The only difference consists in that the first and second journal 217, 218 are produced separately from one another. At their inner ends, they are inserted into the through-bore 221 of the second journal part 223 and axially secured relative thereto by securing rings 236. At their outer ends, the first and the second journal 217, 218 are produced so as to be integral with the respective bearing disc 237, 238. The bearing discs 237, 238 are positioned in a play-free way in the assembly apertures 216 located diametrically opposite one another in the jacket portion 226.

The differential assembly shown in FIG. 14 largely corresponds to the embodiment shown FIG. 12. To that extent, reference is made to the description of same. The reference numbers of those components corresponding to one another have been increased by 100. The only difference consists in the design of the first and of the second journal 267, 268 which are produced separately from one another. By means of their inner ends, these are inserted into the bores 271 of the second journal part 273 and axially held relative thereto by securing rings, with the securing rings engaging the central aperture 296, thus preventing the journals 267, 268 from moving outwardly. At their outer ends, the first and the second journal 267, 268 are produced so as to be integral with the bearing discs 287, 288 which are positioned in a play-free way in the assembly apertures 266.

FIGS. 15 to 17 will be described jointly below. As far as its design is concerned, the differential assembly as illustrated largely corresponds to a combination of the first two embodiments. To that extent, as far as their common characteristics are concerned, reference is made to the above description, with the reference numbers of those components which correspond to one another being increased relative to the embodiment according to FIGS. 1 to 6, by 300. The present embodiment is characterized in that both the first journal part 322 and the second journal part 323, which jointly form the cross member assembly, are directly connected in respect of drive to the differential carrier 303, with torque being introduced in the circumferential direction from the differential carrier 303 into the journals 317, 318, 319, 320. The first journal part 322 is held in bores 324, 325 in the casing portion. The second journal part 323, by means of its journals 319, 320, is received in bearing discs 337, 338 which, in turn, are positioned in assembly apertures 316. The bearing discs 337, 338 are axially secured relative to the journals 319, 320 by securing rings 336. The assembly apertures 316 in the differential carrier 303 are modified in that the first area 339 is formed by a semicircle whose radius corresponds to the radius of the bearing discs 337, 338. The bearing discs 337, 338 are thus supported in this region relative to the differential carrier 303 in a planar way, which leads to a higher degree of stiffness. The slot-like second area 430 of the assembly apertures 316, at its end afar from the flange 306, is formed by three radii and comprises a central supporting portion 347. The radius of said supporting portion 347 corresponds to the radius of the bearing discs 337, 338, so that it rests against the differential carrier 303 in a planar way.

FIGS. 18 to 20 show a further embodiment and will be described jointly below. The differential assembly as illustrated largely corresponds to that according to FIGS. 15 to 17. To that extent, as far as their common characteristics are concerned, reference is made to the above description, with the reference numbers of those components which correspond to one another having been increased once more by 50. The third and the fourth journal 369, 370 have been produced separately from one another and, at their inner ends, are connected to the first journal part 372. For this purpose, the third and the fourth journal 369, 370, at their inner ends, each comprise a plug-in projection 398, 399 by means of which they are plugged into a central through-bore 400 of the first journal part 372. The journals 369, 370 are axially secured relative to the second journal part 372 by means of securing rings 386 which engage annular grooves in the through-bore 400. At their outer ends, the third and the fourth journal 369, 370 comprise integrally formed-on bearing discs 387, 388 which are positioned in the assembly apertures 366 of the differential carrier 353 and are drivingly connected thereto in the circumferential direction.

FIG. 21 shows an embodiment which is similar to that illustrated in FIG. 14, to the description of which reference is hereby made. The reference numbers of those components which correspond to one another have again been increased by 50. In the present embodiment, all four journals 417, 418, 419, 420 are connected to the differential carrier 403 in the circumferential direction, so that torque can be transmitted to same. The first and the second journal 417, 418 form a common cylindrical first journal part 422 which is inserted into bores 424, 425 of the differential carrier 403, which bores are diametrically opposed to one another. The third and the fourth journal 419, 420 are produced separately from one another and, by means of their inner ends, are inserted into a support element 423. The support element 423 is substantially annular in shape and comprises a through-aperture 446 which extends coaxially relative to the axis of rotation, as well as four bores extending radially relative thereto. Each two of the bores 421 are positioned on a common axis, with the first journal part 422 being inserted into a first pair of bores and the third and the fourth journal 419, 420 being inserted into bores extending transversely thereto. The third and the fourth journal 419, 420 are produced so as to be integral with the associated bearing disc 437, 438 which is positioned in a play-free way in the assembly apertures 416.

FIGS. 22 and 23 which will be described jointly below show a further embodiment which largely corresponds to the embodiment which is described in FIGS. 1 to 6 and to the description of which reference is hereby made regarding the common characteristics. Those components which correspond to one another have been given reference numbers increased by 450. The differential assembly shown here is provided in the form of a bevel gear differential instead of a crown gear differential. It can be seen that the differential gears 458 and the sideshaft gears 459, 460 are provided in the form of bevel gears. The assembly apertures are positioned in a different sectional plane and, therefore, are not visible. As can be seen in FIG. 23, the cross member assembly 457 largely corresponds to that illustrated in FIG. 2. It is appreciated that the inventive idea is not restricted to the bevel gear differential as illustrated. On the contrary, other characteristics, too, of the above-described crown gear differentials could be transferred to a bevel gear differential without deviating from the inventive idea.

1-27. (canceled)

28. A differential assembly, for use in the driveline of a motor vehicle, comprising:
a differential carrier rotatingly drivable around an axis of rotation (A) and, in a casing portion, comprises at least one assembly aperture and in each of two cover portions arranged opposite one another, comprises an integrally formed-on bearing projection;
sideshaft gears which can be inserted into said differential carrier through the said assembly aperture and, in the mounted condition, are rotatably held in said differential carrier on said axis of rotation;
four differential gears which can be inserted into the differential carrier through the assembly aperture and, in said mounted condition, rotate together with the differential carrier around the axis of rotation and engage said sideshaft gears;
a cross member assembly which is rotationally drivingly connected to said differential carrier and comprises four journals, wherein said four journals, in the mounted condition, each carry one of said differential gears and wherein at least two of said four journals are designed in such a way that they can be inserted through said assembly aperture, wherein said differential carrier comprising said casing portion and said cover portion is produced in one piece;
wherein a first one and a second one of the four journals jointly form a first journal part which is drivingly connected to the differential carrier in respect of rotation thereof;
wherein a third one and a fourth one of the four journals, with their inner ends, are at least indirectly connected to the first journal part and, with their outer ends, are drivingly connected to the differential carrier in respect of rotation thereof by means of bearing discs, which bearing discs are accommodated in the assembly apertures of the differential carrier.

29. A differential assembly according to claim 28, wherein the third journal and the fourth journal jointly form a second journal part which is drivingly connected to said differential carrier in respect of rotation thereof, wherein the first and second journal part are connected to one another.

30. A differential assembly according to claim 29, wherein in said casing portion of said differential carrier, in the circumferential direction between said two assembly apertures, there are provided bores into which said first journal part is inserted with its first and its second journals.

31. A differential assembly according to claim 29, wherein said second journal part is inserted with its third and its fourth journals into said bearing discs.

32. A differential assembly according to claim 29, wherein said second journal part comprises a transversely extending through-bore into which there is inserted said first journal part.

33. A differential assembly according to claim 29, wherein said second journal part comprises shoulders against which the differential gears are able to abut on the inside.

34. A differential assembly according to claim 28, wherein the third journal and the fourth journal are produced separately and, on their respective insides, are connected to said first journal part and, on their respective outsides, are drivingly connected to said differential carrier in respect of rotation thereof.

35. A differential assembly according to claim 34, wherein said third and fourth journal, at their inner ends, each comprise a plug-in projection by means of which they are inserted into a central through-bore of said first journal part.

36. A differential assembly according to claim 34, wherein said third and fourth journals, at their outer ends, are integrally formed with said bearing discs by means of which they are accommodated in said assembly apertures of said differential carrier and are drivingly connected to said differential carrier in respect of rotation thereof.

37. A differential assembly according to claim 28, wherein said first journal part carries a support element and that the third and the fourth journal are produced separately and, on their respective insides, are connected to said support element and, on their outsides, are drivingly connected to said differential carrier in respect of rotation thereof.

38. A differential assembly according to claim 37, wherein in the casing portion of said differential carrier, in the circumferential direction between said two assembly apertures there are provided bores into which there is inserted said first journal part with its first and second journals.

39. A differential assembly according to claim 37, wherein said support element comprises a first through-bore which extends perpendicularly relative to said axis of rotation (A) and into which there is inserted said first journal part, as well as two further bores which extend perpendicularly relative to said axis rotation (A) and into which there are inserted said third and the fourth journal.

40. A differential assembly according to claim 37, wherein, per journal, said support element comprises a shoulder against which said respective differential gears are able to abut at least indirectly on the inside.

41. A differential assembly according to claim 37, wherein said third and fourth journals, at their out ends, comprise integrally formed-on bearing discs by means of which they are accommodated in said assembly apertures of said differential carrier and are drivingly connected to said differential carrier in respect to rotation thereof.
